(19) United States
(12) Patent Application Publication
(10) Pub. No.: US 2009/0056844 A1
(43) Pub. Date: Mar. 5, 2009

(54) Protective auxiliary fuel pump handle for pumping gasoline

(76) Inventor: Andreas Schanz, Norco, CA (US)

Correspondence Address: Andreas Schanz, 2451 Roundup Road, Norco, CA, 92860, US

(21) Appl. No.: 12/231,203

(22) Filed: Aug. 28, 2008

Related U.S. Application Data
(60) Provisional application No. 60/967,315, filed on Sep. 5, 2007.

(51) Int. Cl. B65D 65/22; B67D 5/06

(52) U.S. Cl. 150/154; 141/392

(57) ABSTRACT

A protective auxiliary fuel pump handle for pumping gasoline comprises an interior semi-circumferential wrapping means made of semi-rigid material for shape retention and appropriate fit on top of a gas station fuel pump handle. It includes an exterior handle means that is of a single embodiment made of flexible material. Said interior wrapping means and said exterior handle means are adhered to each other by means of adhesive or similar fastening means. Optionally, said interior wrapping means and said exterior handle means can be manufactured monolithically so long as the two materials can achieve their separate, appropriate flexibility/rigidity. To pump gasoline a motorist will place this auxiliary fuel pump handle on top of a gas station pump handle so as to substantially prevent his/her hand from coming into physical contact with the gas station fuel pump handle, thus maintaining hygiene of his/her hand as well as preventing the spread of bacteria and/or diseases. The handle is designed to be able to be used by both right-handed and left-handed persons. The size of said handle means is designed such that it can accommodate hand sizes ranging from small to large.

### CROSS-REFERENCE TO RELATED APPLICATION

This application claims the benefit of U.S. provisional patent application 60/967,315 filed under 35 U.S.C. § 119(e) on Sep. 5, 2007 and entitled “Auxiliary fuel pump handle for hygiene and prevention of disease”.

### BACKGROUND OF THE INVENTION

1. Field of the Invention

This invention relates generally to the field of gas station pump equipment such as would be found at a self-service gas station. Moreover it pertains specifically to an auxiliary fuel pump handle for pumping gasoline, which is to be conveniently placed on top of a gas station fuel pump handle and remain there until the fuel dispensing process is completed.

2. Description of the Prior Art

Commonly, fuel pump handles are designed to provide a comfortable grip surface for a motorist to be able to grab the gas station fuel pump and insert the gas station fuel pump nozzle into the gas tank of their vehicle in order to dispense fuel into said tank. While offering a comfortable grip usually made out of rubber, a common fuel pump handle presents a perfect breeding ground for bacteria as well as an object coated with fuel vapor residue. While a motorist can resort to taking a paper towel or similar measure of hygiene and wrap it around the fuel pump handle to alleviate the soiling of their hand, this method does not provide for much convenience. A paper towel also allows any fuel vapor residue from the gas station fuel pump handle to permeate through the paper towel and end up on the motorist's hand causing offensive odor as well as potential dermatological health problems. Additionally, if it were windy, the paper towel would tend to be blown away by the wind causing a motorist to have to get another paper towel or resort to holding the paper towel in place during the entire fuel dispensing process. In conclusion, insofar as I am aware, all fuel pump handles formerly developed do not provide a means to prevent a motorist's hand from becoming soiled by bacteria or fuel vapor deposits in order to maintain hand hygiene and/or prevent the spread of diseases caused by bacteria. Also, all fuel pump handles formerly developed do not prevent a person from spreading their bacteria and germs to the fuel pump handle thus contaminating it with bacteria that can potentially spread a disease to hundreds of people. The present invention will provide a solution for the shortcoming of such prior arts.

The other aspect of prior arts and their approach to alleviate the contamination of hands with fuel vapor residue is to provide a glove made of gasoline-impermeable material for pumping gasoline at a self-service gas station. While providing protection from such contamination said gloves are inconvenient and cumbersome to use in that they need to remain on the motorist's hand during the entire fuel dispensing process. Most of said gloves are meant to be disposable after each use thus presenting an undue strain on the environment. None of these protective gloves in prior inventions and patents is seen to disclose a device that substantially emulates an existing gas station fuel pump handle that can remain placed on top of a gas station fuel pump handle unattended for the entire fuel dispensing process, is designed to be non-disposable and that can be used for an indefinite amount of times as will be subsequently described and claimed in the instant invention.

### SUMMARY OF THE INVENTION

The invention overcomes the disadvantages in the related art in a new and useful auxiliary fuel pump handle that is conducive for pumping gasoline while maintaining hand hygiene & the health of motorists and is an effective device to prevent the soiling of hands with fuel vapor residue as well as substantially reduce the spread of bacteria and germs.

The present invention generally comprises an interior semi-circumferential wrapping means that is made of substantially semi-rigid material for shape retention and suitable for appropriate fit on top of a gas station fuel pump handle; the embodied shape of said wrapping means possesses varying thickness to best suit a wide variety of gas station pump handles. It includes a handle means that is of a single embodiment made of substantially flexible material exterior to said wrapping means. Said interior wrapping means and said exterior handle means are adhered to each other by means of adhesive or similar fastening means. Optionally, said interior wrapping means and said exterior handle means can be manufactured monolithically so long as the two materials can achieve their separate, appropriate flexibility/rigidity respective to their function. The handle is designed to be able to be used by both right-handed and left-handed persons. The size of the handle is designed such that it can accommodate hand sizes ranging from small to large.

The purpose of the present invention is to provide a convenient and highly functional means to prevent a motorist's hand from becoming soiled by fuel residue or fuel vapors and to alleviate the spread of bacteria, germs and diseases when pumping fuel at a self-service gas station. The novelty of the present invention is that it can easily be placed on top of a gas station fuel pump handle without effort and then rest there unattended during the fuel dispensing process due to its semi-rigid wrapping means. After the fuel dispensing process is completed the device can easily be removed from the gas station fuel pump handle and placed inside of the vehicle for the next time the vehicle needs refueling. The present invention allows a motorist to substantially reduce physical contact with the gas station fuel pump handle. The novelty of the present invention not offered by any prior art apparatus results in a new protective auxiliary fuel pump handle for pumping gasoline which is not apparent, obvious, or suggested, either directly or indirectly by any prior arts. The advantages of the present invention over prior arts will become apparent from a study of the following description and the accompanying drawings.

The foregoing has outlined, in general, the physical aspects of the invention and is to serve as an aid to better understanding the more complete detailed description, which is to follow. In reference to such, there is to be a clear understanding that the present invention is not limited to the method or detail of construction, fabrication, material, or application of use described and illustrated herein. Any other variation of fabrication, use, or application should be considered apparent as an alternative embodiment of the present invention.

Accordingly several advantages and objects of the present invention are:

A principal advantage of the auxiliary fuel pump handle for pumping gasoline is to provide a means to maintain hand hygiene for a motorist when dispensing fuel from a self-service gas station fuel pump system that will overcome the deficiencies of any prior arts.

Another advantage of the auxiliary fuel pump handle for pumping gasoline is to alleviate physical contact with a self-service gas station fuel pump handle to prevent the spread of diseases as well as bacteria and germs.

Another advantage of the auxiliary fuel pump handle for pumping gasoline is to provide a means for a sick person to avoid transferring bacteria from their hand onto a self-service gas station fuel pump handle thus being able to substantially prevent the spread of their sickness to other motorists.

Another advantage of the auxiliary fuel pump handle for pumping gasoline is that the hand of a motorist is substantially protected from gasoline vapors, odors, bacteria, germs and the like.

Another advantage of the auxiliary fuel pump handle for pumping gasoline is to provide a convenient means to allow motorists to avoid touching a self-service gas station fuel pump handle.

Another advantage of the auxiliary fuel pump handle for pumping gasoline is that it is designed to be washable.

Another advantage of the auxiliary fuel pump handle for pumping gasoline is that it can be of any color.

Another advantage of the auxiliary fuel pump handle for pumping gasoline is that it can be conveniently stored in the interior of a vehicle after the fuel dispensing process and retrieved for the next time fueling is necessary.

Another advantage of the auxiliary fuel pump handle for pumping gasoline is that it is designed to be non-disposable and re-useable for an indefinite amount of times.

It is intended that any other advantages and objects of the present invention that become apparent or obvious from the detailed description or illustrations contained herein are within the scope of the present invention.

### BRIEF DESCRIPTION OF THE DRAWINGS

The following drawings further describe by illustration the advantages and objects of the present invention. Each drawing is referenced by corresponding figure reference numbers within the “DETAILED DESCRIPTION OF THE INVENTION” section to follow.

FIG. 1. is a perspective view of the auxiliary fuel pump handle itself according to the present invention.

FIG. 2. is a perspective view of the present invention being held by a motorist's hand.

FIG. 3. is a perspective view of the present invention properly placed on top of a self-service gas station fuel pump handle.

FIG. 4. is a cross sectional view of the present invention seen in FIG. 3, taken along line 3-3 of that drawing.

### DETAILED DESCRIPTION OF THE INVENTION

Referring now descriptively to the drawings, the attached figures illustrate an auxiliary fuel pump handle for pumping gasoline.

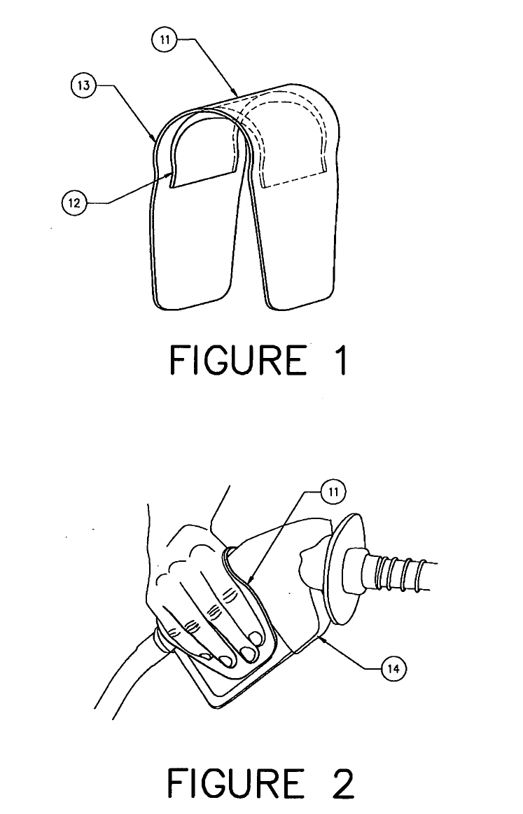

FIG. 1 illustrates a perspective view of the auxiliary fuel pump handle 11, also depicting the interior wrapping means 12 in relation to the exterior handle means 13.

In usage, a motorist first retrieves the auxiliary fuel pump handle 11 from inside the vehicle. He or she then places said fuel pump handle 11 properly on top of the gas station fuel pump handle 14 while grabbing both to remove said gas station fuel pump handle 14 from the gas station storage housing as illustrated in the perspective view in FIG. 2 and subsequently is able to proceed with the fuel dispensing process by actuating the trigger of said gas station fuel pump handle 14 to pump gas.

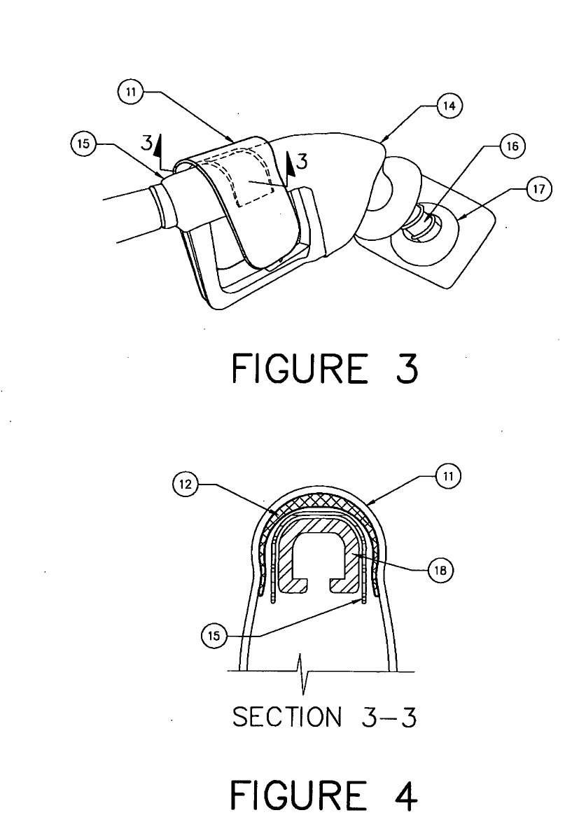

FIG. 3 is a perspective view of the auxiliary fuel pump handle 11 resting on top of a gas station fuel pump handle 14 while the fuel pump nozzle 16 is inserted into the fuel tank opening 17 of a vehicle.

FIG. 4 is a lateral cross section as represented by section line 3-3 in FIG. 3 through the auxiliary fuel pump handle 11 and the gas station fuel pump handle 14. The section illustrates the auxiliary fuel pump handle 11 resting on top of the gas station fuel pump handle grip material 15 on top of the gas station fuel pump handle metal construction 18.

It is further intended that any other embodiments of the present invention that result from any changes in application or method of use or operation, method of manufacture, shape, size, or material which are not specified within the detailed written description or illustrations contained herein yet are considered apparent or obvious to one skilled in the art are within the scope of the present invention.

I claim:

1. A washable and re-useable auxiliary fuel pump handle for pumping gasoline, comprising:
(a) An interior semi-circumferential wrapping means made of substantially semi-rigid material to retain shape suitable for placement on top of a gas station fuel pump and
(b) a handle means made of substantially flexible material exterior to said wrapping means, said handle means being flexible enough to enable a human hand to squeeze through said handle means to easily actuate the gas station fuel pump trigger to dispense gasoline, said handle means being substantially larger than said wrapping means, suited to entirely protect a motorist's hand from contact with the gas station fuel pump handle and trigger and being substantially impermeable to liquids such as gasoline and diesel fuel.

2. The auxiliary fuel pump handle as recited in claim 1, wherein said wrapping means and said handle means are made of substantially anti-static materials so as to substantially prevent sparks or a fire when a potential buildup of static electricity could discharge by coming into contact with a gas station fuel pump handle.
